(19) United States
(12) Patent Application Publication
(10) Pub. No.: US 2021/0016180 A1
(43) Pub. Date: Jan. 21, 2021

(54) System and Method for a Virtual Stock Market Sharing and Trading Game

(71) Applicant: Tafadzwa Chinamo, Harare (ZW)

(72) Inventor: Tafadzwa Chinamo, Harare (ZW)

(21) Appl. No.: 16/933,986

(22) Filed: Jul. 20, 2020

Related U.S. Application Data
(60) Provisional application No. 62/876,423, filed on Jul. 19, 2019.

(51) Int. Cl. A63F 13/79; A63F 13/35; A63F 13/533; G06Q 40/06; G06Q 40/04

(52) U.S. Cl. CPC A63F 13/79; A63F 13/35; G06Q 40/04; G06Q 40/06; A63F 13/533

(57) ABSTRACT

A system and method for a virtual stock market sharing and trading game facilitates learning of sharing and trading stocks. The system includes at least one remote server which manages a plurality of player accounts and a plurality of virtual stocks. Each player account can be accessed by a corresponding player personal computing (PC) device. The remote server further manages a virtual gameboard and processes a plurality of game actions. Each of the plurality of game actions is related to real-life situations which may occur when sharing and trading stocks. Each of the plurality of game actions is associated with a game space on the virtual gameboard. Further, the plurality of game actions can affect a usable-funds ledger and investment portfolio associated with player accounts and the virtual stocks. The method of player accounts performing the plurality of game actions continues until a player reaches a cash threshold.

The current application claims a priority to the U.S. Provisional Patent application Ser. No. 62/876,423 filed on Jul. 19, 2019. The current application is filed on Jul. 20, 2020 while Jul. 19, 2020 was on a weekend.

### FIELD OF THE INVENTION

The present invention relates generally to data processing. More specifically, the present invention is a system and method for a virtual stock market sharing and trading game.

### BACKGROUND OF THE INVENTION

Trading of assets forms a crucial part of the modern world. For instance, trading activities carried out at exchanges significantly contribute to the economic growth and prosperity of a region. Accordingly, various facilities have been developed in order to encourage and support the participation of individuals in trading exchanges. For instance, several tools have been developed in order to educate individuals in the field of trading assets such as stocks. As an example, existing methods may provide multimedia content through devices that provide an enhanced learning experience to individuals. However, the resulting learning is largely passive and not effective in training individuals to tackle real-world scenarios in stock exchanges. Another technique provided by existing methods includes creating a virtual stock exchange which simulates the functioning of a real stock exchange in order to train individuals in performing trading activities effectively. However, such virtual stock exchanges tend to be overwhelming to most users resulting in a poor learning curve.

Therefore, it is an objective of the present invention to provide a system and method for a virtual stock market sharing and trading game which facilitates learning of trading and sharing shares of stocks. The present invention provides various situations for players in which they can learn strategies in trading and sharing shares of stocks.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method to facilitate learning of trading based on the game of the present invention is disclosed. Accordingly, the method may include a step of receiving, using a communication device, one or more requests from one or more player devices associated with one or more of players. Further, the method may include a step of initializing, using a processing device, a virtual game board interface based on the one or more requests. Further, the method may include a step of transmitting, using the communication device, the virtual game board interface to the one or more player devices. Further, the method may include a step of receiving, using the communication devices, one or more throw events from one or more player devices. Further, the method may include a step of updating, using the processing device, one or more positions of one or more bells associated with the one or more players based on the one or more throw events. Further, the method may include a step of receiving, using the communication device, one or more marketing actions from the one or more player devices based on the one or more positions of the one or more bells on the trading game board. Further, the method may include a step of generating, using the processing device, one or more investment portfolios associated with the one or more players based on the one or more marketing actions. Further, the method may include a step of transmitting, using the communication device, the one or more investment portfolios to the one or more player devices. Further, the method may include a step of analyzing, using the processing device, the one or more investment portfolios based on one or more winning criteria. Further, the method may include a step of determining, using the processing device, one or more winners based on the analyzing. Further, the method may include a step of transmitting, using the communication device, indication of the one or more winners to the one or more player devices.

According to some aspects, a method to facilitate learning of trading based on a game of the present invention in accordance with some embodiments is disclosed. Accordingly, the method may include a step of receiving, using a communication device, one or more requests from one or more player devices associated with one or more of players. Further, the method may include a step of retrieving, using a storage device, virtual exchange data from a database. Further, the method may include a step of initializing, using a processing device, a virtual game board interface based on the one or more requests. Further, the method may include a step of transmitting, using the communication device the virtual game board interface and the virtual exchange data to the one or more player devices. Further, the method may include a step of receiving, using the communication devices, one or more throw events from the one or more player devices. Further, the method may include a step of transmitting, using the communication device, one or more cards associated with the one or more positions of the one or more bells to the one or more player devices. Further, the method may include a step of receiving, using the communication device, one or more marketing actions from the one or more player devices based on the one or more positions of the one or more bells on the trading game board. Further, the method may include a step of generating, using the processing device, one or more investment portfolios associated with the one or more players based on the one or more marketing actions. Further, the method may include a step of transmitting, using the communication device, the one or more investment portfolios to the one or more player devices. Further, the method may include a step of analyzing, using the processing device, the one or more investment portfolios based on one or more winning criteria to determine one or more winners. Further, the method may include a step of transmitting, using the communication device, indication of the one or more winners to the one or more player devices.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a system diagram of the present invention.

FIG. 2A is a flowchart illustrating the overall method of the present invention.

FIG. 2B is a continuation of the flowchart from FIG. 2A.

FIG. 3 is a flowchart illustrating the subprocess for the trading game spaces.

FIG. 4 is a flowchart illustrating the subprocess for the virtual card decks.

FIG. 5 is a flowchart illustrating the subprocess for the forced-sale game space.

FIG. 6 is a flowchart illustrating the subprocess for the opening-bell game space.

FIG. 7 is a flowchart illustrating the subprocess for brokerage-refund game space.

FIG. 8 is a flowchart illustrating the subprocess for the compulsory-delisting game space.

FIG. 9 is a flowchart illustrating the subprocess for the dividend game space.

FIG. 10 is a flowchart illustrating the subprocess for the buy-or-sell game space.

FIG. 11 is a flowchart illustrating the subprocess for the rights-issue game space.

FIG. 12 is a flowchart illustrating the subprocess for the capital-gains-tax game space.

FIG. 13 is a flowchart illustrating the subprocess allowing a player account to view the investment portfolio.

FIG. 14 is a flowchart illustrating the subprocess allowing a player account to view the usable-funds ledger.

FIG. 15 is a screenshot of a trading home for the game of the present invention, in accordance with an embodiment.

FIG. 16 is a screenshot of an investment portfolio for the game of the present invention, in accordance with an embodiment.

FIG. 17 is a screenshot of a stock portfolio for the game of the present invention, in accordance with an embodiment.

FIG. 18 is a screenshot of an options portfolio for the game of the present invention, in accordance with an embodiment.

FIG. 19 is a screenshot of short sale positions for the game of the present invention, in accordance with an embodiment.

FIG. 20 is a screenshot of dividends for the game of the present invention, in accordance with an embodiment.

FIG. 21 is a screenshot of cash for the game of the present invention, in accordance with an embodiment.

FIG. 22 is a screenshot of a playing board for the game of the present invention, in accordance with an embodiment.

FIG. 23 is a screenshot of live orders for the game of the present invention, in accordance with an embodiment.

FIG. 24 is a screenshot of my orders for the game of the present invention, in accordance with an embodiment.

FIG. 25 is a screenshot of a price sheet for the game of the present invention, in accordance with an embodiment.

FIG. 26 is a screenshot of a leader board for the game of the present invention, in accordance with an embodiment.

FIG. 27 is a screenshot of a virtual card for the game of the present invention, in accordance with an embodiment.

FIG. 28 is a screenshot of returns (top 5 and bottom 5) for the game of the present invention, in accordance with an embodiment.

FIG. 29 is a screenshot of a play button for the game of the present invention, in accordance with an embodiment.

FIG. 30 is a screenshot of a sample stock fact sheet for the game of the present invention, in accordance with an embodiment.

FIG. 31 is a screenshot of sample virtual cards from the virtual card decks for the game of the present invention, in accordance with an embodiment.

### DETAIL DESCRIPTIONS OF THE INVENTION

All illustrations of the drawings are for the purpose of describing selected versions of the present invention and are not intended to limit the scope of the present invention.

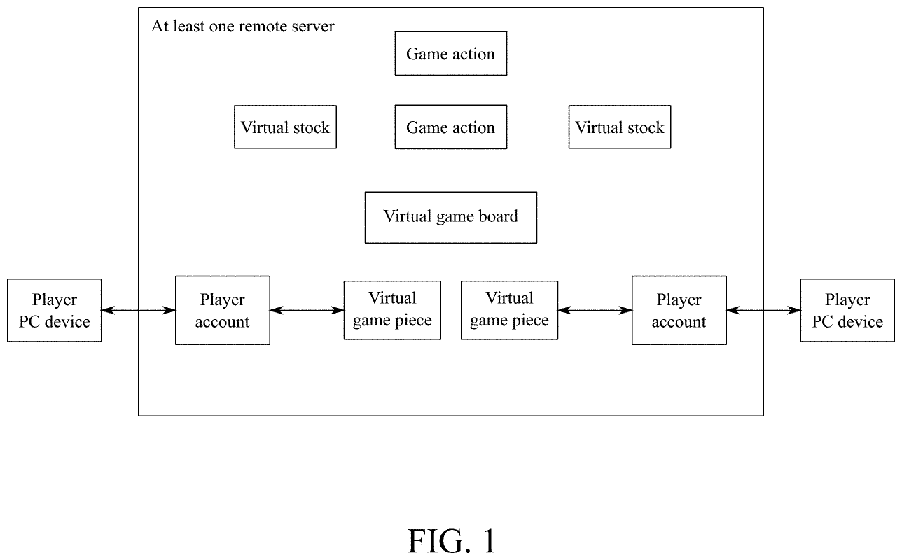

In reference to FIGS. 1 through 14, the present invention is a system and method for a virtual stock market sharing and trading game which facilitates learning of trading and sharing shares of stocks. With reference to FIG. 1, the system of the present invention includes at least one remote server that manages a plurality of player accounts and a plurality of virtual stocks (Step A). Each player account is associated with a corresponding player personal computing (PC) device, and each player account includes a usable-funds ledger and an investment portfolio. The remote server is preferably a cloud server where all the processes of the present invention can be executed and managed. The player PC device may be any type of computing device such as, but not limited to, a mobile phone, a mobile tablet, a desktop computer, or a notebook computer. The usable-funds ledger is a virtual cash manager for each player account. In further detail, the usable-funds ledger includes an initial amount of usable virtual cash and a list of all transactions made by the player. In the preferred embodiment of the present invention, the initial amount of usable virtual cash is $1,000,000.00. The investment portfolio is a virtual stock manager for each player account. In further detail, the investment portfolio allows each player account to manage his or her shares of stocks. The plurality of virtual stocks may be related to various companies in sectors such as, but not limited to, a consumer discretionary sector, a consumer staple sector, an energy sector, a financial sector, a healthcare sector, an industrial sector, a materials sector, a real estate sector, a technology sector, a telecom sector, or a transport sector. The remote server also manages a virtual gameboard and a plurality of game actions (Step B). The virtual gameboard includes a loop of game spaces, and each game space is associated with at least one corresponding game action from the plurality of game actions. A virtual game piece for each player account is situated onto a current game space form the loop of game spaces, and the virtual gameboard is associated with a winning cash threshold. The virtual gameboard provides a virtual platform simulating a gameboard on which the method of the present invention can be processed. The loop of game spaces provides various spaces on which the virtual game piece of each player account can be moved onto in order to produce or request an action related to gameplay. The plurality of game actions includes virtual actions related to stock sharing and trading in order to educate users in the practice of sharing and trading stocks. The virtual game piece may be any piece that defines a position for each player account on the virtual gameboard. The winning cash threshold is a final cash amount that a player account must reach or pass in order to win the game.

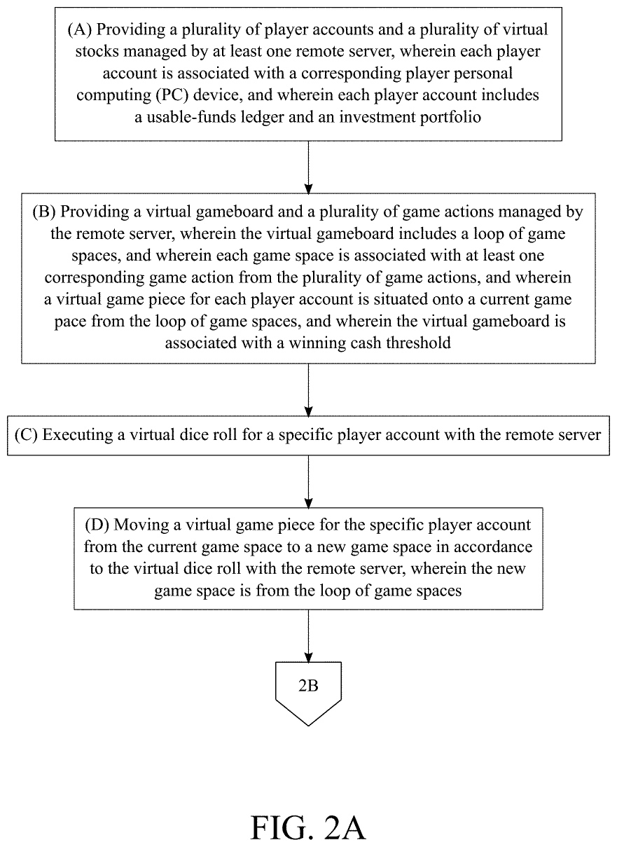

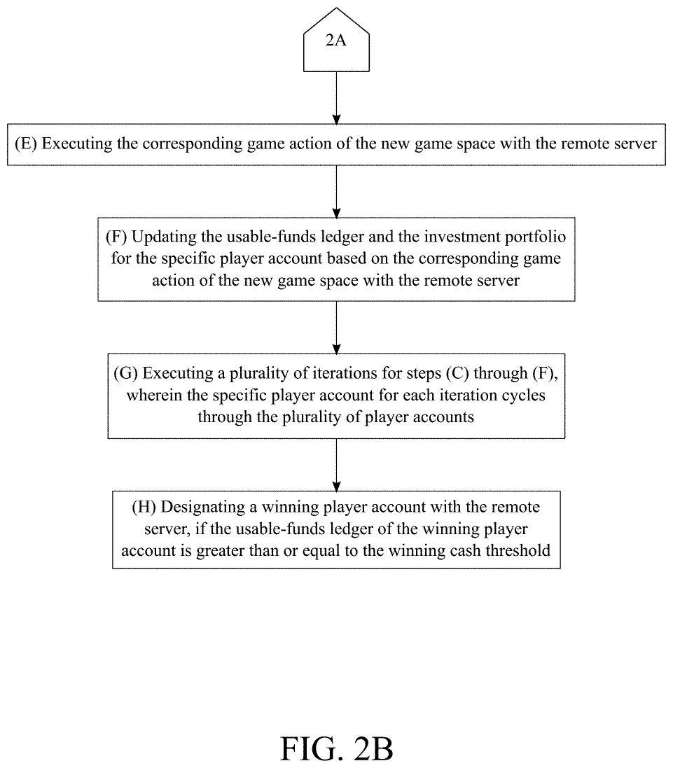

With reference to FIGS. 2A and 2B, the method of the present invention follows an overall process which facilitates the learning of sharing and trading stocks. The remote server executes a virtual dice roll for a specific player account (Step C). The virtual dice roll determines how many spots the virtual game piece of the specific player account will move across the loop of game spaces. The remote server moves the virtual game piece for the specific player account from the current game space to a new game space in accordance to the virtual dice roll (Step D). The new game space is from the loop of game spaces. Step D automatically moves the virtual game piece of the specific player account to the new game spaces based on the random number of spaces determined by the virtual dice roll. The remote server executes the corresponding game action of the new game space (Step E). The corresponding game action is an action related to sharing and trading stocks such as, but not limited to, buying and/or selling shares of virtual stocks, depositing a brokerage refund, or withdrawing capital gains tax for shares of a virtual stock. The remote server updates the usable-funds ledger and the investment portfolio for the specific player account in accordance to the corresponding game action (Step F). In further detail, the cash may be deposited into or withdrawn from the usable-funds ledger of the specific player account and/or the shares of stocks may be added into or removed from the investment portfolio. A plurality of iterations for Steps C through F is executed (Step G). The specific player account for each iteration cycles through the plurality of player accounts. In further detail, the remote server executes a virtual dice roll and corresponding game action for each player account based on a turn-based sequential pattern pre-determined by the remote server. The remote server designates a winning player account, if the usable-funds ledger of the winning player account is greater than or equal to the winning cash threshold (Step H). In further detail and in the preferred embodiment of the present invention, the winning player account ends the game when his or her usable-funds ledger reaches or passes $1,500,000.00.

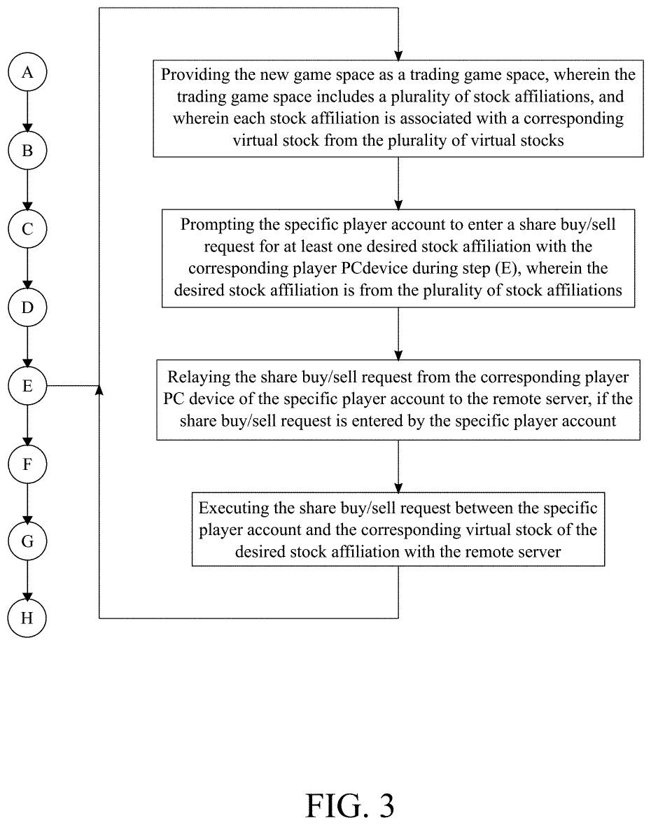

With reference to FIG. 3, the following subprocess is one of the plurality of game actions. The new game space is provided as a trading game space. The trading game space includes a plurality of stock affiliations, and each stock affiliation is associated with a corresponding virtual stock from the plurality of virtual stocks. In further detail, the trading game space is a space that lists and displays multiple virtual stocks when a player account lands on a trading game space. The corresponding player PC device prompts the specific player account to enter a share buy/sell request for at least one desired stock affiliation during Step E. The desired stock affiliation is from the plurality of stock affiliations. In further detail, the specific player account is given the option to purchase or sell shares of a particular stock that is listed by the trading game space. The corresponding player PC device relays the share buy/sell request of the specific player account to the remote server, if the share buy/sell request is entered by the specific player account. Thus, the particular game action of buying and/or selling shares of stocks can be processed by the remote server. The remote server then executes the share buy/sell request between the specific player account and the corresponding virtual stock of the desired stock affiliation. Thus, the specific player account is provided with shares of the desired stock affiliation and/or provided with a cash amount equal to the sold shares of the desired stock affiliation.

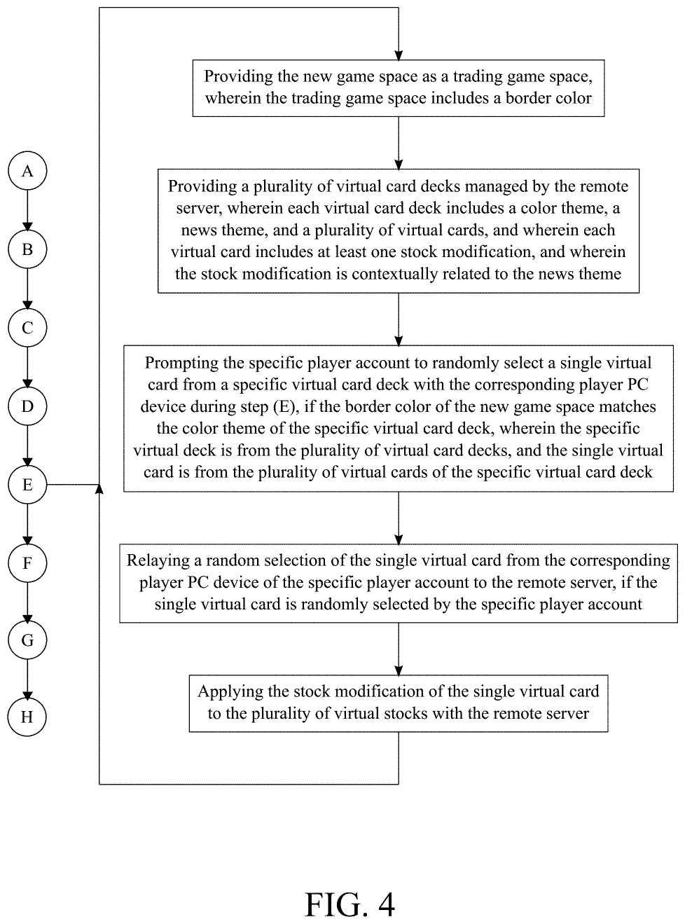

With reference to FIG. 4, the following subprocess is another one of the plurality of games actions. The trading game space includes a border color and the remote server manages a plurality of virtual card decks. Each virtual card deck includes a color theme, a news theme, and a plurality of virtual cards. Each virtual card includes at least one stock modification, and the stock modification is contextually related to the news theme. The border color identifies which virtual deck a player account will draw from after landing on a trading game space. In the preferred embodiment of the present invention, the news theme may be, but is not limited to, company performance, industry developments, economic developments, or market sentiment. The stock modification is related to what is read on the virtual cards. Based on the information provided on the virtual cards, prices of the virtual stocks may rise or fall. The corresponding player PC device prompts the specific player account to randomly select a single virtual card from a specific virtual card deck during Step E, if the border color of the new game space matches the color theme of the specific virtual deck. The specific virtual deck is from the plurality of virtual card decks, and the single virtual card is from the plurality of virtual cards of the specific virtual card deck. In further detail, the specific player account is required to draw a card from the plurality of virtual card decks based on the border color of the trading game space after the specific player account buys and/or sells shares of stock to end his or her turn. The corresponding player PC device relays the random selection of the single virtual card to the remote server, if the single virtual card is randomly selected by the specific player account. Thus, the particular game action of drawing and reading a news card can be processed by the remote server. The remote server then applies the stock modification of the single virtual card to the plurality of virtual stocks. In further detail, the single virtual card is displayed for each player account to view and based on what the single virtual card reads, prices of the virtual stocks may rise or fall.

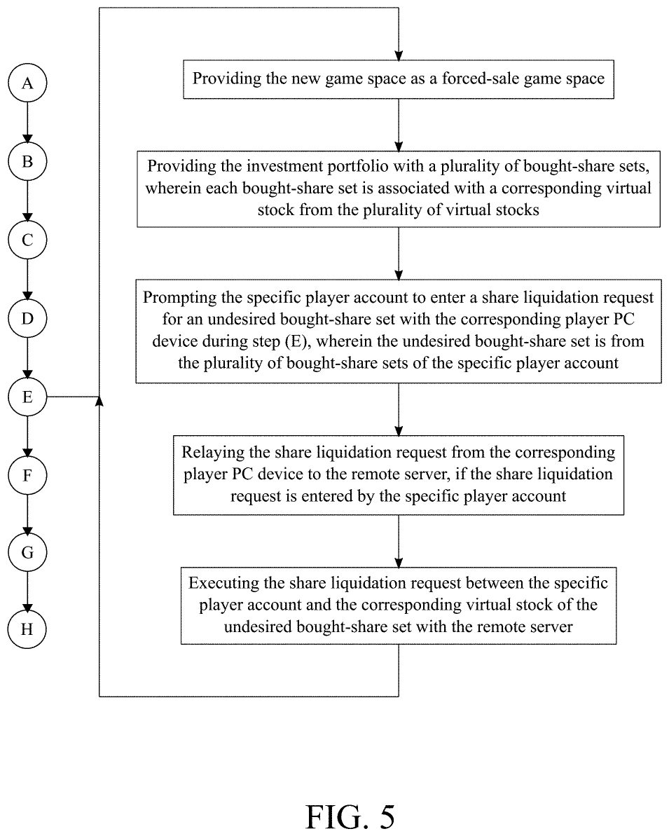

With reference to FIG. 5, the following subprocess is another one of the plurality of game actions. The new game space is provided as a forced-sale game space. The forced-sale game space requires a player account to forcibly sell all shares of a single virtual stock. The investment portfolio is provided with a plurality of bought-share sets. Each bought-share set is associated with a corresponding virtual stock from the plurality of virtual stocks. In further detail, the bought-share sets are included into a stock portfolio that includes shares of every virtual stock a player account has purchased throughout the game. The corresponding player PC device prompts the specific player account to enter a share liquidation request for an undesired bought-share set during Step E. The undesired bought-share set is from the plurality of bought-share sets of the specific player account. In further detail, a player account is required to choose a single virtual stock where all the shares will be sold. The corresponding player PC device relays the share liquidation request to the remote server, if the share liquidation request is entered by the specific player account. Thus, the forced-sale game action can be processed by the remote server. The remote server executes the share liquidation request between the specific player account and the corresponding virtual stock of the undesired bought-share set. In further detail, all the shares of a chosen stock are forcibly sold by a player account.

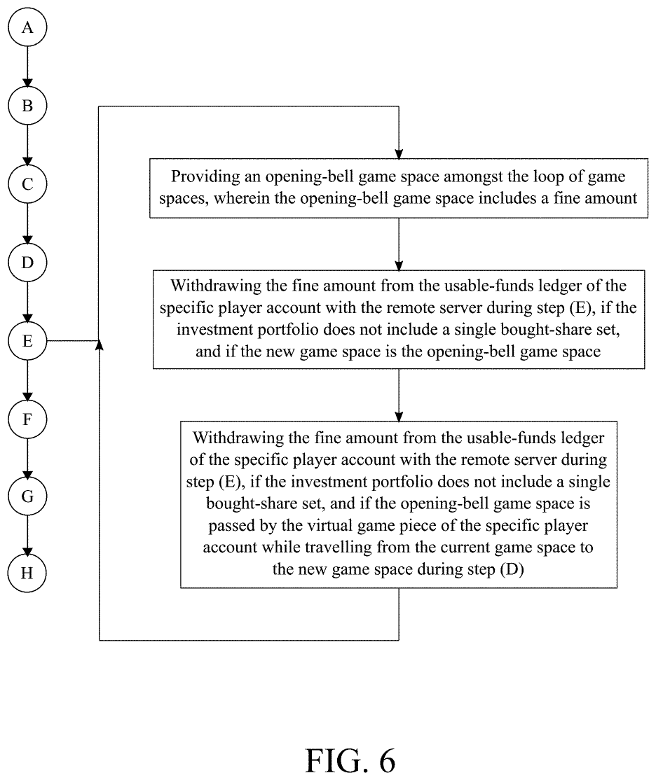

With reference to FIG. 6, the following subprocess is another one of the plurality of game actions. An opening-bell game space is provided amongst the loop of game spaces. The opening-bell game space includes a fine amount. The opening-bell game space is the first space where all player accounts start when a new game is initiated. As the game progresses, player accounts may land on or pass the opening-bell game space. The fine amount is preferably $50,000.00 and is required when a player account lands on or passes the opening-bell game space and if the player account has not purchased any shares of the virtual stocks. The remote server withdraws the fine amount from the usable-funds ledger of the specific player account during Step E, if the investment portfolio does not include a single bought-share set, and if the new game space is the opening-bell game space. In further detail, this step requires a player account to pay the fine amount if the virtual game piece of the player account lands on the opening-bell game space and if the player account has not purchased any shares of the virtual stocks. Alternatively, the remote server withdraws the fine amount from the usable-funds ledger of the specific player account during Step E, if the investment portfolio does not include a single bought-share set, and if the opening-bell game space is passed by the virtual game piece of the specific player account while travelling from the current game space to the new game space during Step D. In further detail, this step requires a player account to pay the fine amount if the virtual game piece of the player account passes the opening-bell game space during his or her turn and if the player account has not purchased any shares of the virtual stocks.

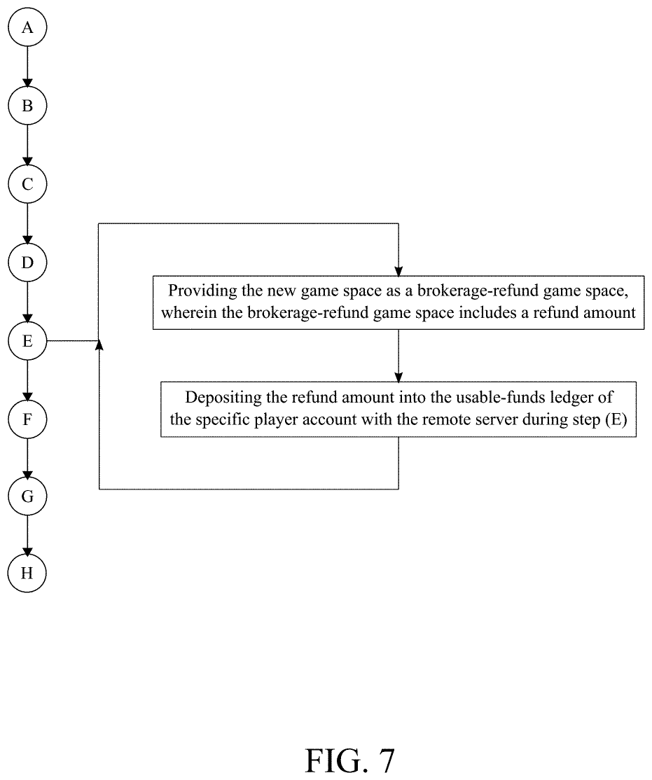

With reference to FIG. 7, the following subprocess is another one of the plurality of game actions. The new game space is provided as brokerage-refund game space. The brokerage-refund game space includes a refund amount. The brokerage-refund game space provides a set cash amount to a player account if the player account lands on the brokerage-refund game space. The refund amount is preferably $50,000.00. The remote server deposits the refund amount into the usable-fund ledger of the specific player account during Step E. Thus, the specific player account receives the refund amount for landing on the brokerage-refund game space.

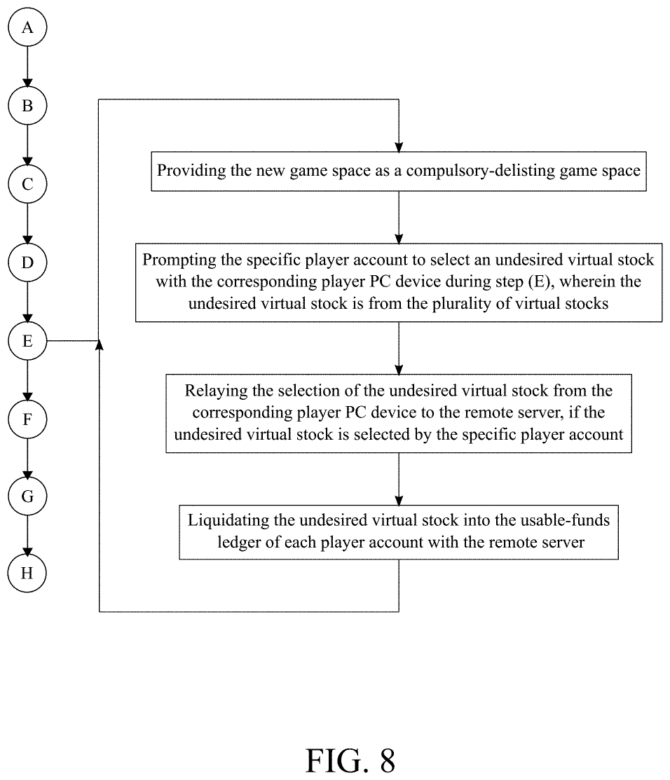

With reference to FIG. 8, the following subprocess is another one of the plurality of game actions. The new game space is provided as a compulsory-delisting game space. The compulsory-delisting game space requires a player account to delist a virtual stock from the plurality of virtual stocks when the player account lands on the compulsory-delisting game space. The corresponding player PC device prompts the specific player account to select an undesired virtual stock during Step E. The undesired virtual stock is from the plurality of virtual stocks. In further detail, a player account is required to choose a virtual stock from the plurality of virtual stocks in order to delist the chosen virtual stock. The corresponding player PC device relays the selection of the undesired virtual stock to the remote server, if the undesired virtual stock is selected by the specific player account. Thus, the delisting of virtual stock game action can be processed by the remote server. The remote server liquidates the undesired virtual stock into the usable-funds ledger of each player account. In further detail, every player account, that owns shares of the newly delisted stock, receives cash for his or her shares.

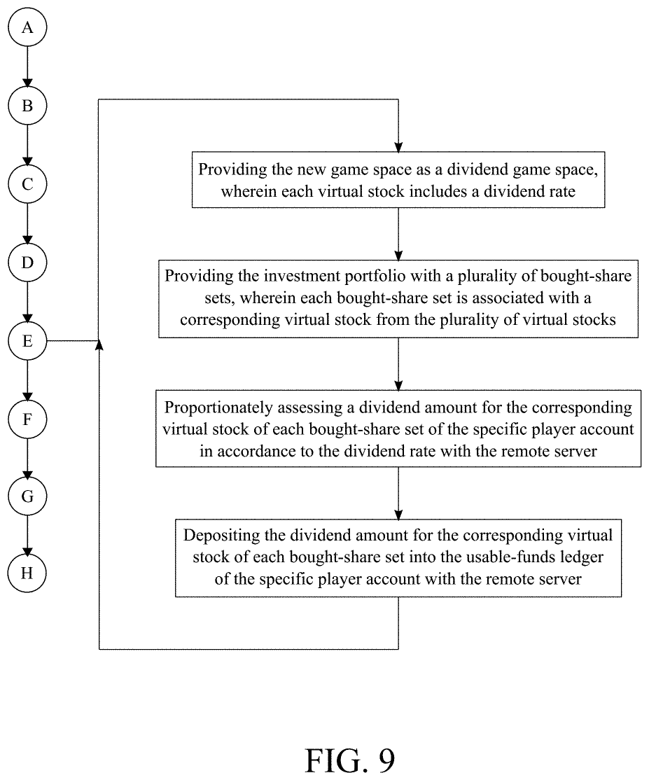

With reference to FIG. 9, the following subprocess is another one of the plurality of game actions. The new game space is provided as a dividend game space. Each virtual stock includes a dividend rate. The dividend rate is pre-determined rate for each virtual stock. The dividend game space provides cash to a player account based on total shares owned of virtual stocks and the dividend rate of the virtual stocks. The remote server proportionately assesses a dividend amount for the corresponding virtual stock of each bought-shared set of the specific player account in accordance to the dividend rate. In further detail, the remote server calculates dividend amounts for the total shares of each virtual stock that a player account has purchased and the dividend rate of each virtual stock. The remote server deposits the dividend amount for the corresponding virtual stock of each bought-share set into the usable-funds ledger of the specific player account. Thus, a player account receives dividends for the total shares of the virtual stocks that the player account has purchased when the virtual game piece of the player account lands on the dividend game space.

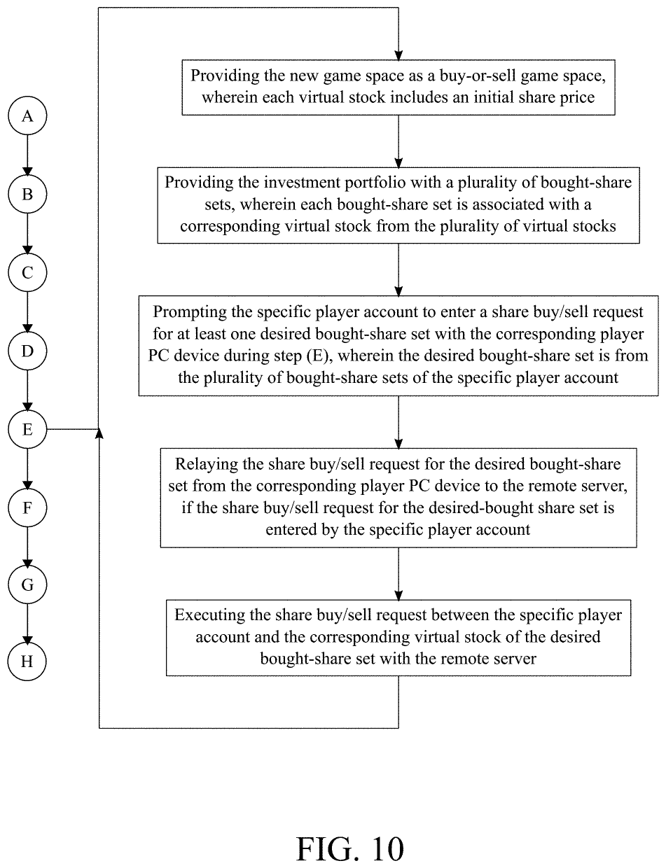

With reference to FIG. 10, the following subprocess is another one of the plurality of game actions. The new game space as a buy-or-sell game space. The buy-or-sell game space allows a player account to purchase or sell shares of any virtual stock that the player account has previously purchased during the game. In the preferred embodiment, the buy-or-sell game space restricts a player account from purchasing or selling shares of up to five virtual stocks. The corresponding player PC device prompts the specific player account to enter a share buy/sell request for at least one desired bought-share set during Step E. The desired bought-share set is from the plurality of bought-share sets. In further detail, the specific player account is given the option to purchase or sell shares of virtual stocks owned by the specific player account. The corresponding player PC device relays the share buy/sell request for the desired bought-share set to the remote server, if the share buy/sell request for the desired bought-share set is entered by the specific player account. Thus, the buy/sell game action can be processed by the remote server. The remote server executes the share buy/sell request between the specific player account and the corresponding virtual stock of the desired bought-share set. Thus, shares of virtual stocks are included into the investment portfolio and/or cash is deposited into the usable-funds ledger for any sold shares of virtual stocks.

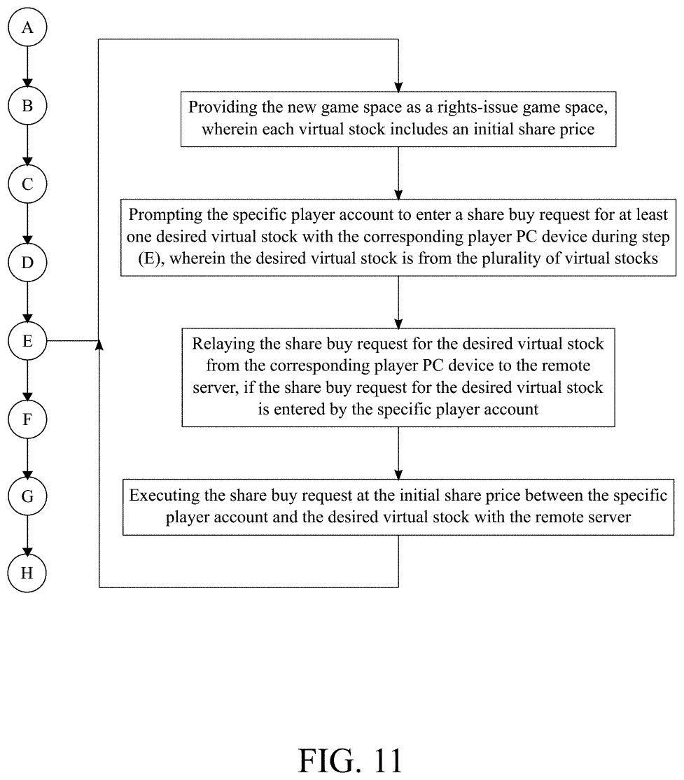

With reference to FIG. 11, the following subprocess is another one of the plurality of game actions. The new game space as a rights-issue game space. Each virtual stock includes an initial share price. The rights-issue game space allows a player account to purchase shares of any virtual stock from the plurality of virtual stocks at the initial share price. This may be beneficial to a player account if a current share price of the virtual stocks is higher than the initial share price. In the preferred embodiment, the rights-issue game space restricts a player account from purchasing shares of up to five virtual stocks. The corresponding player PC device prompts the specific player account to enter a share buy request for at least one desired virtual stock during Step E. The desired virtual stock is from the plurality of virtual stocks. In further detail, the specific player account is given the option to purchase shares of any virtual stock from the plurality of virtual stocks. The corresponding player PC device relays the share buy request of the desired virtual stock to the remote server, if the share buy request for the desired virtual stock is entered by the specific player account. Thus, the rights-issue game action can be processed by the remote server. The remote server executes the share buy request at the initial share price between the specific player account and the desired virtual stock. Thus, a player account can purchase shares of virtual stocks at the initial share price and can benefit if the current share price is higher than the initial share price.

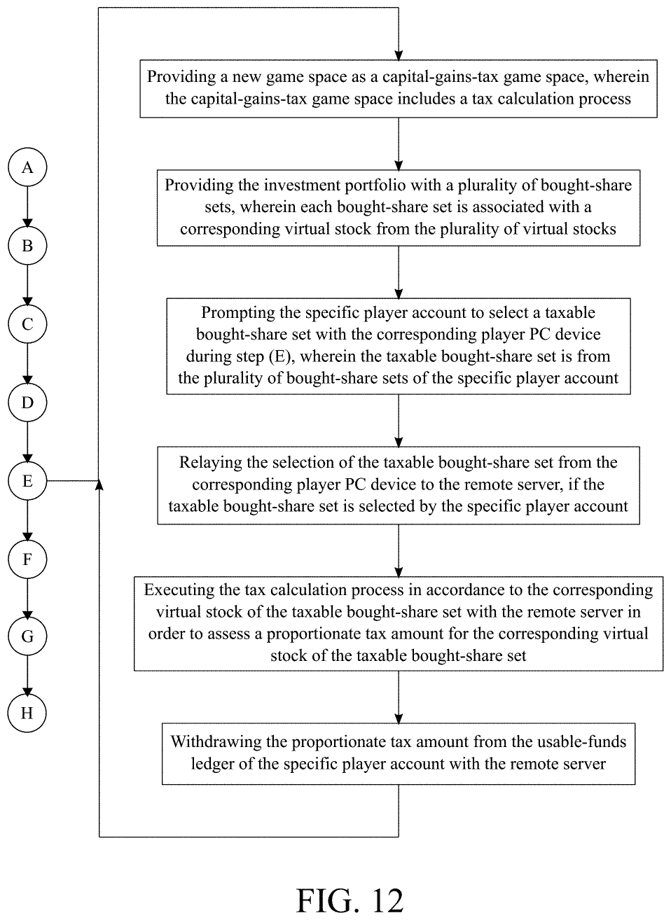

With reference to FIG. 12, the following subprocess is another one of the plurality of game actions. The new game space is provided as a capital-gains-tax game space. The capital-gains-tax game space includes a tax calculation process. The tax calculation process calculates the tax of 10,000 shares of a particular virtual stock based on the current share price. In the preferred embodiment, the capital-gains-tax game space requires a player account to pay a cashed amount equal to the tax of 10,000 shares of one virtual stock of the stocks previously purchased by the player account when the virtual game piece of the player account lands on the capital-gains-tax game space. Further, if a player account has not purchased any shares of the virtual stocks, then the player account is not required to pay when the virtual game piece of the player account lands on the capital-gains-tax game space. The corresponding player PC device prompts the specific player account to select a taxable bought-share set during Step E. The taxable bought-share set is from the plurality of bought-share sets of the specific player account. This step requires the specific player account to select a virtual stock from the virtual stock shares that the specific player owns in order to be taxed on the selected virtual stock. The corresponding player PC device relays the selection of the taxable bought-share set to the remote server, if the taxable bought-share set is selected by the specific player account. Thus, the capital gains tax game action can be processed by the remote server. The remote server executes a tax calculation process in accordance to the corresponding virtual stock of the taxable bought-share set in order to assess a proportionate tax amount for the corresponding virtual stock of the taxable bought-share set. In further detail, the proportionate tax amount is equal to the tax of 10,000 shares of the virtual stock that a player account has chosen to be taxed. The remote server withdraws the proportionate tax amount from the usable-funds ledger of the specific player account. Thus, a player account is required to pay tax equal to 10,000 shares of a virtual stock.

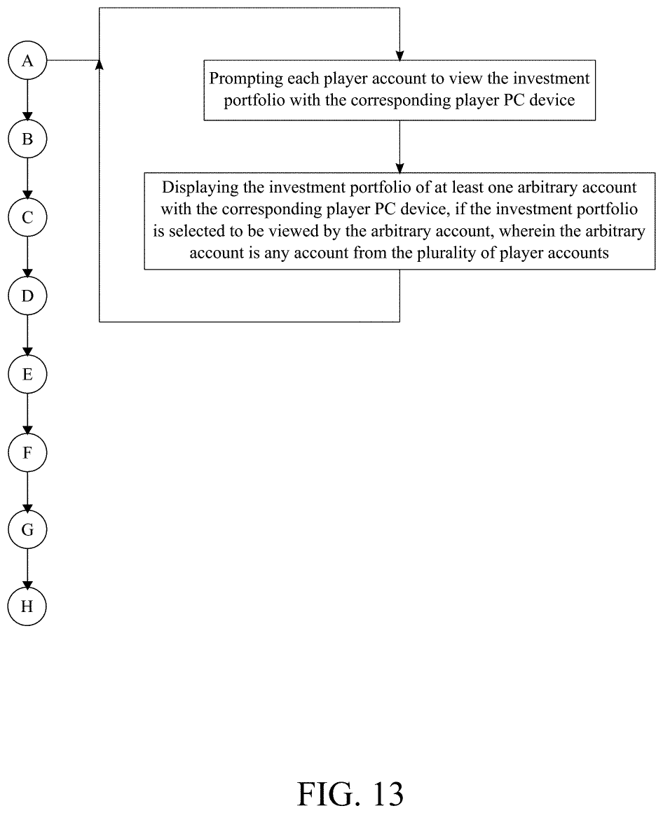

With reference to FIG. 13, the following subprocess allows each player account to view his or her investment portfolio. The corresponding player PC device prompts each player account to view the investment portfolio. In further detail, each player account has the option to view his or her investment portfolio at any time during the game. The corresponding player PC device displays the investment portfolio of at least one arbitrary account, if the investment portfolio is selected to be viewed by the arbitrary account. The arbitrary account is any account from the plurality of player accounts. Thus, the investment portfolio is displayed for a player account when he or she selects to view the investment portfolio.

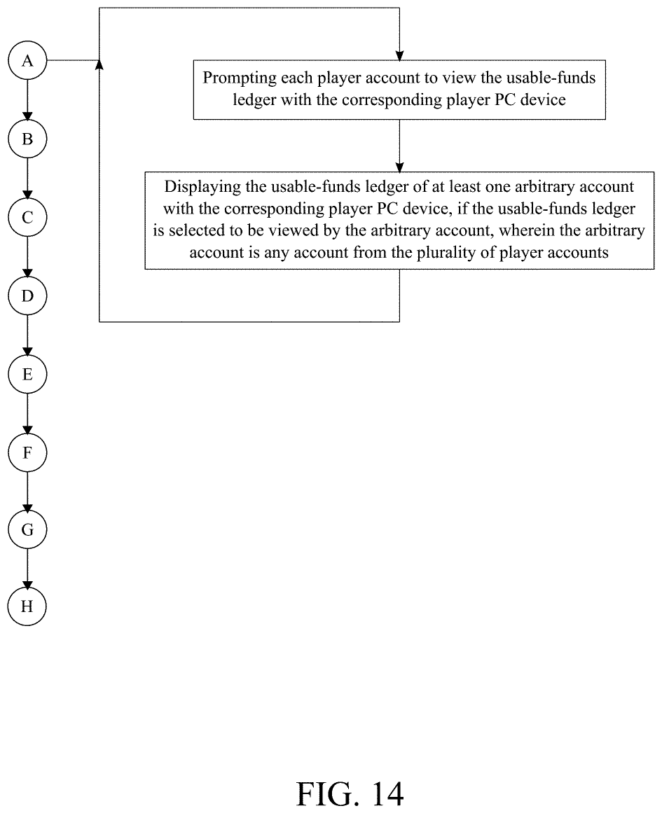

With reference to FIG. 14, the following subprocess allows a player account to view his or her usable-funds ledger. In the preferred embodiment, the usable-funds ledger may be included into cash tab of the investment portfolio. The corresponding player PC device prompts each player account to view the usable-funds ledger. This step provides each player account the option view his or her usable-funds ledger at any time during the game. The corresponding player PC device displays the usable-funds ledger of at least one arbitrary account, if the usable-funds ledger is selected to be viewed by the arbitrary account. The arbitrary account is any account from the plurality of player accounts. Thus, the usable-funds ledger is displayed for a player account when he or she selects to view the usable-funds ledger.

### Supplemental Description

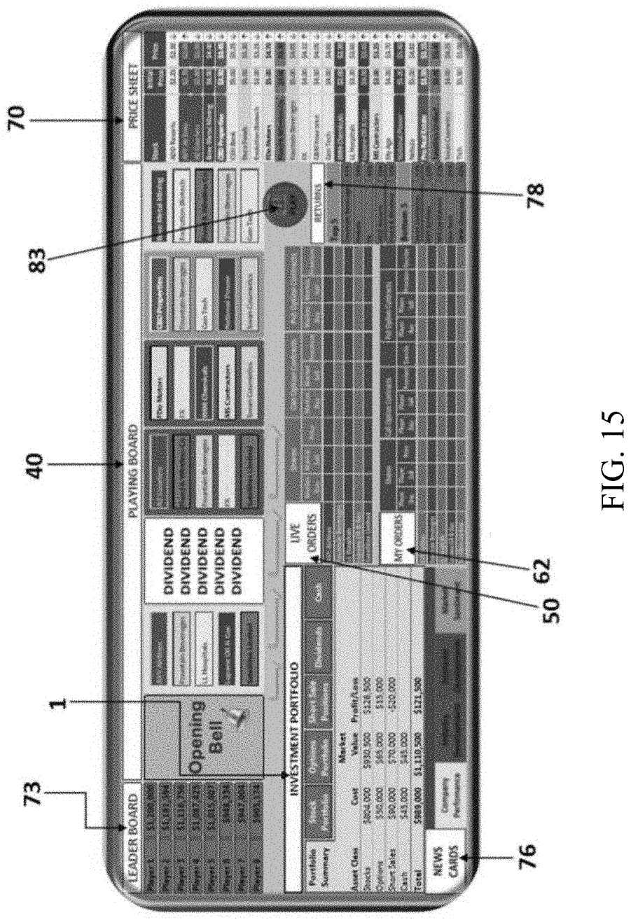

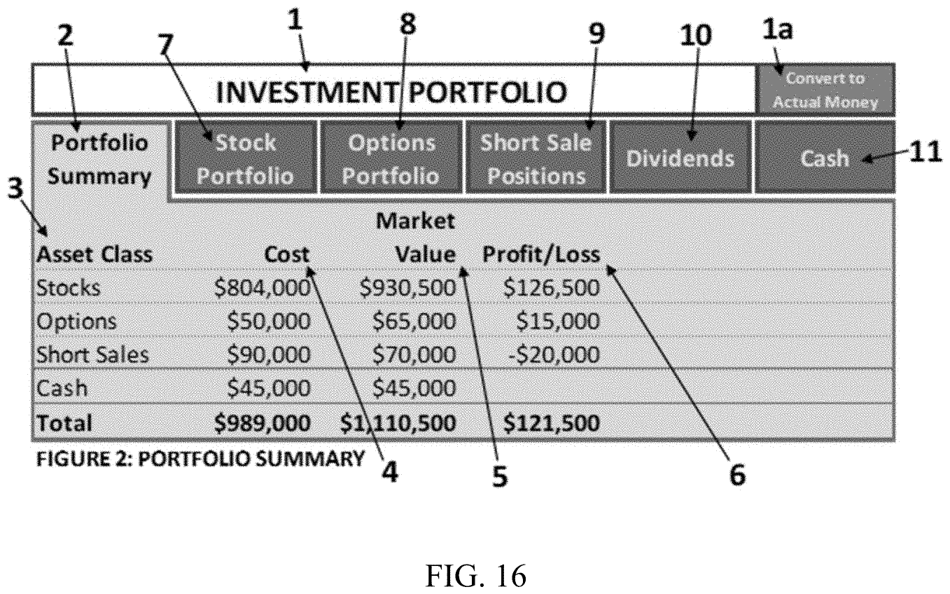

FIG. 15 is a screenshot of a trading home for the game of the present invention, in accordance with an embodiment. FIG. 16 is a screenshot of an investment portfolio 1 for the game of the present invention, in accordance with an embodiment. Further, the investment portfolio 1 may include several tabs such as a portfolio summary 2, a stock portfolio 7, an options portfolio 8, a short sale positions 9, a dividends 10, a cash 11 and a convert to actual money 1a. Further, the portfolio summary 2 may be the default screen and may display a summary of all the securities held by the player account according to asset class 3. Further, the portfolio summary 2 may show the cost 4, market value 5 and profit/loss 6 for each asset class 3. Further, the convert to actual money may provide the player account to convert the virtual money used in the game into the actual money. Further, clicking convert to actual money 1a may convert the figures in the investment portfolio from virtual money into actual money in a game where the player accounts may be using actual money.

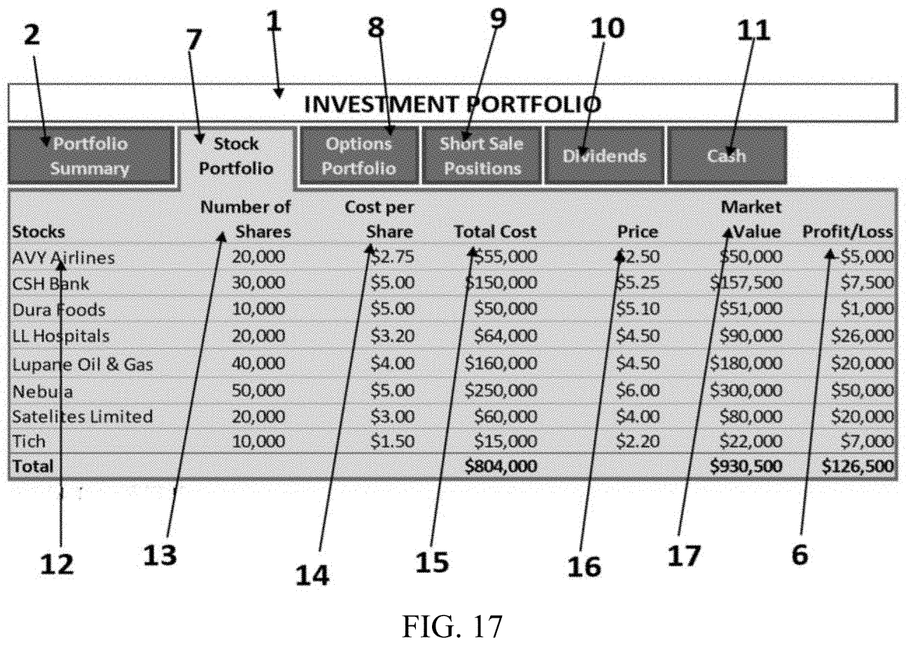

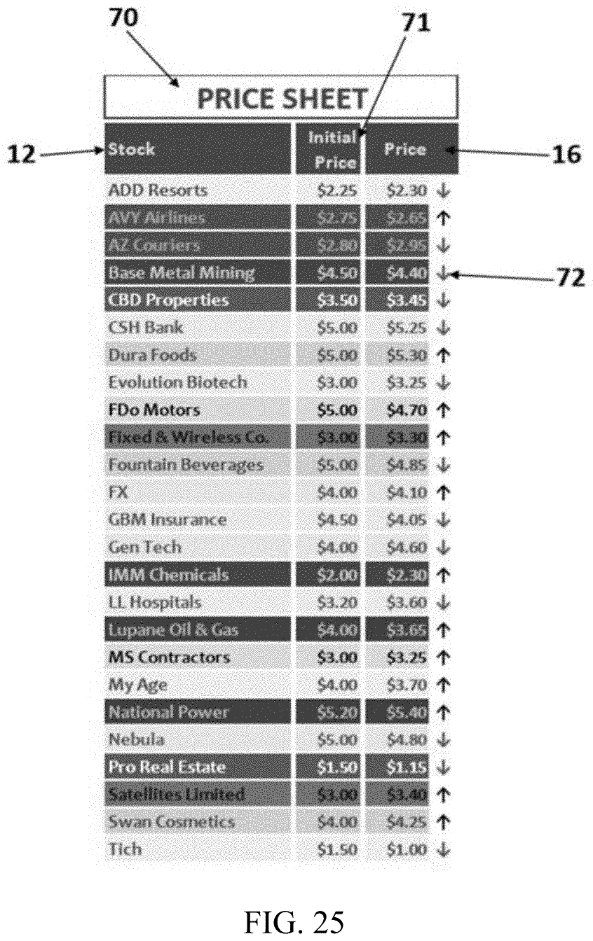

The investment portfolio may include several tabs such as, but not limited to, a portfolio summary, a stock portfolio, an options portfolio, a short sale positions, and dividends. FIG. 17 is a screenshot of a stock portfolio 7 for the game of the present invention, in accordance with an embodiment. Further, the screenshot of the stock portfolio 7 may provide a breakdown of all the stocks 12 held by a player account. Further, the stock portfolio 7 may show the number of shares 13 owned, cost per share 14, total cost 15, the current price per share, market value 17 of the shares and profit or loss for each stock. Further, the stock portfolio 7 may include all the stocks 12 held by the player account. Further, a first column in the stock portfolio 7 may show the name of stocks 12 held by the player account. Further, a second column in the stock portfolio 7 may provide the number of shares 13 corresponding to the respective stocks 12 held by the player account. Further, a third column in the stock portfolio 7 may indicate the cost per share 14 corresponding to the respective stocks 12 held by the player account. Further, a fourth column in the stock portfolio 7 may indicate total cost 15 for each of the respective stocks 12. Further, the total cost 15 may provide the amount used to buy all the shares of the respective stocks 12. Further, a fifth column in the stock portfolio 7 may indicate a price 16 for each of the respective stocks 12. Further, the price 16 may be the current price 16 of the stocks 12 from a price sheet 70, as shown in FIG. 25. Further, a sixth column in the stock portfolio 7 may include a market value 17 for each of the respective stocks 12. Further, the market value 17 may be obtained by multiplying the number of shares 13 by the price 16 for each of the respective stocks 12. Further, a seventh column in the stock portfolio 7 may indicate a profit/loss 6 for each of the respective stocks 12. Further, the profit/loss 6 may show the return the stocks 12 at the current stock price 16 for each of the respective stocks 12. Further, the return may be a positive number indicating profit or a negative number indicating a loss for each of the respective stocks 12.

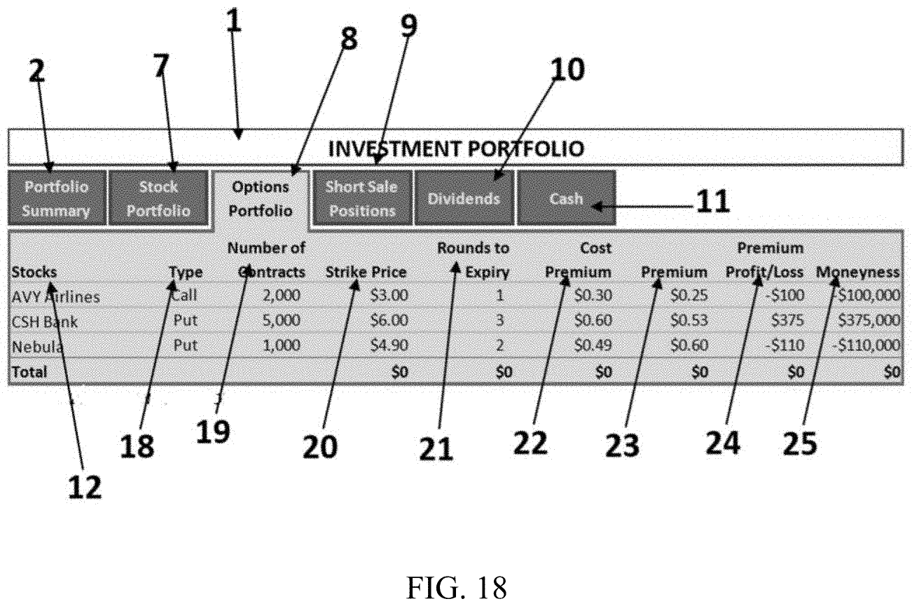

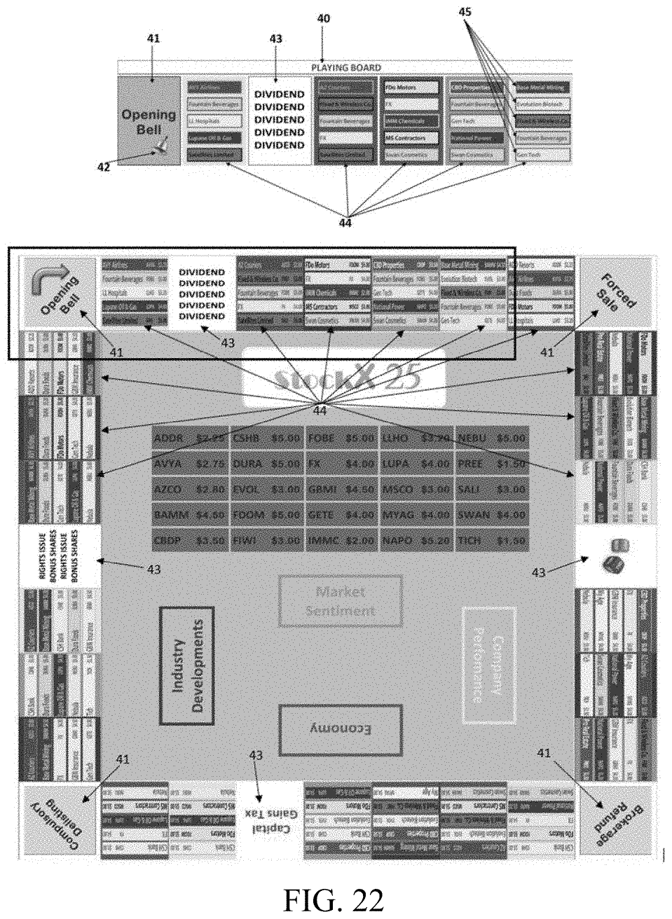

FIG. 18 is a screenshot of an options portfolio 8 for the game of the present invention, in accordance with an embodiment. Further, the options portfolio 8 may provide a breakdown of all stock options held by a player account for each of the respective stocks 12. Further, the options portfolio 8 may provide the stock options for each of the respective stocks 12 held by the player account. Further, the stock options may include a type 18, number of contracts 19, a strike price 20, rounds to expiry 21, a cost premium 22, a current premium 23, a premium profit/loss 24 on the premium and a moneyness 25. Further, type 18 may indicate an option for each of the respective stock. Further, the option may include call or put. Further, the number of contracts may be a number of option contracts 19. Further, the number of option contracts 19 may be a set of options on a hundred shares for each of the respective stocks 12. Further, the strike price 20 may be a price 16 at which the holder of shares may buy or sell the shares for each of the respective stocks 12 after exercising the option. Further, the rounds to expiry 21 may be an expiration date of the option for each of the respective stocks 12. Further, the expiration time of the option may be measured by the number of times the bell 42, as shown in FIG. 22, may go past the opening bell square. Further, the cost premium 22 may be a price at which the option may be purchased. Further, the cost premium 22 may be 10% of the current price 16 for each of the respective stocks 12, at the time the option may be purchased. Further, for a put option, the premium 23 may increase when the current price 16 for each of the respective stocks 12 may fall below the strike price 20 and may decrease when the current price 16 for each of the respective stock may rise above the strike price 20. Further, to capture the increasing value of the put premium a method may be employed. Further, the method may include, dividing the magnitude of price 16 falls below the strike price 20 by ten and adding the result to the cost premium 22. Further, to capture the decreasing value of the put premium a method may be employed. Further, the method may include, dividing the magnitude of price gain above the strike price 20 by ten and subtracting the resultant from the cost premium 22. Further, the premium profit/loss 24 may be an unrealized profit or loss on the premium 23 to the holder of shares before the expiry. Further, the unrealized profit or loss on the premium 23 to the holder of shares may be the premium cost subtracted from the premium 23 multiplied by the number of underlying shares. Further, the moneyness 25 may show the profit or loss the holder of shares may stand to make if the options may be exercised for each of the respective stocks 12 trading at the current Price 16. Further, a positive figure for a call option may mean the current price 16 may be greater than the strike price 20 and so the each of the respective stocks 12 may be bought at the strike price 20 and may be immediately sold for a profit at the current price 16. Further, a negative figure may mean a transaction would result in a loss and therefore the holder of shares may rather let the option expire without exercising the option. Further, a positive figure for a put option may mean the current price 16 may be less than the strike price 20 and so the each of the respective stocks 12 may be bought at the current price 16 and may be sold immediately at the strike price 20 for a profit. Further, a negative figure may mean a transaction would result in a loss and therefore the holder of shares let the option expire unexercised.

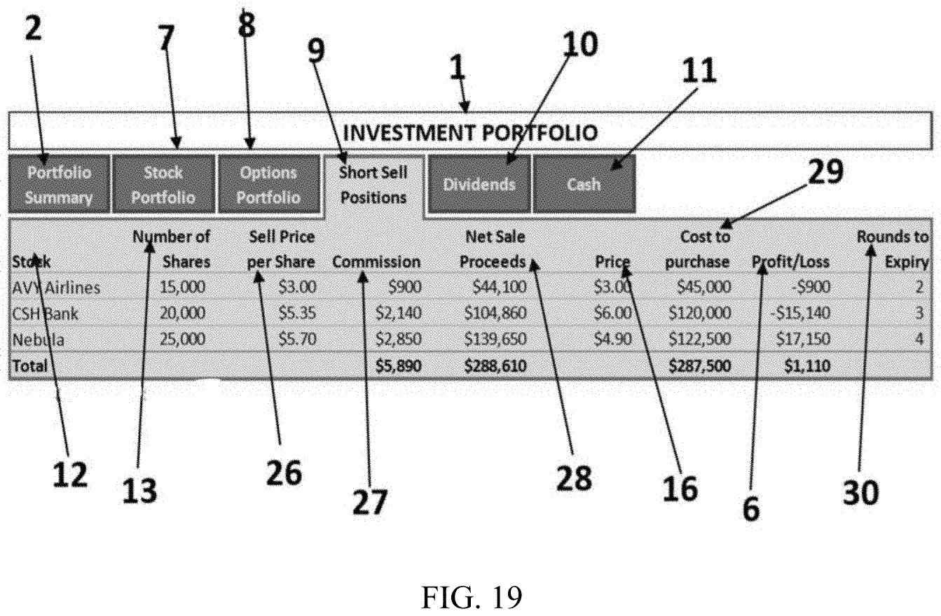

FIG. 19 is a screenshot of short sale positions 9 for the game of the present invention, in accordance with an embodiment. Further, the short sale positions 9 may provide a breakdown of all the short sale positions 9 held by a player account. Further, the short sale positions 9 may include a number of shares 13 sold short, a sell price per share 26, a commission 27, net sale proceeds 28, a current share price, a cost to purchase 29, a profit or loss and rounds to expiry 30, for each of the respective stocks 12. Further, the number of shares 13 sold short may indicate the number of shares 13 for each of the respective stocks 12 sold short. Further, the sell price per share 26 may be a price at which the shares may be sold short. Further, the commission 27 may indicate a commission charged by an exchange for extending a facility to the player account. Further, the player account may be charged with a commission of 2% on an amount the player account may receive from short selling shares. Further, the net sale proceeds 28 may indicate the net amount received from the short sale after deducting the Commission. Further, the amount needed for the player account to breakeven on the short sale may be obtained by adding the commission 27 to the net sale proceeds 28 for each of the respective stocks 12. Further, the current share price may indicate a price per share the player account might pay in order to buy the shares and deliver them to the exchange. Further, the current share price of the stock may be indicated on a price sheet 70, as shown in FIG. 25. Further, the cost to purchase 29 may be a cost incurred on the player account for buying the shares and deliver the shares to the exchange. Further, the profit or loss may indicate the profit or loss position on the short sell at the current price 16. Further, the profit or loss may be the cost to purchase 29 subtracted from the net sale proceeds 28. Further, the rounds to expiry 30 may indicate a round to expiry on a short sell obligation. Further, the rounds to expiry 30 may be an expiration time of the option for each of the respective stocks 12. Further, the expiration time of the option may be measured by the number of time the bell 42, as shown in FIG. 22 may go past the opening bell square.

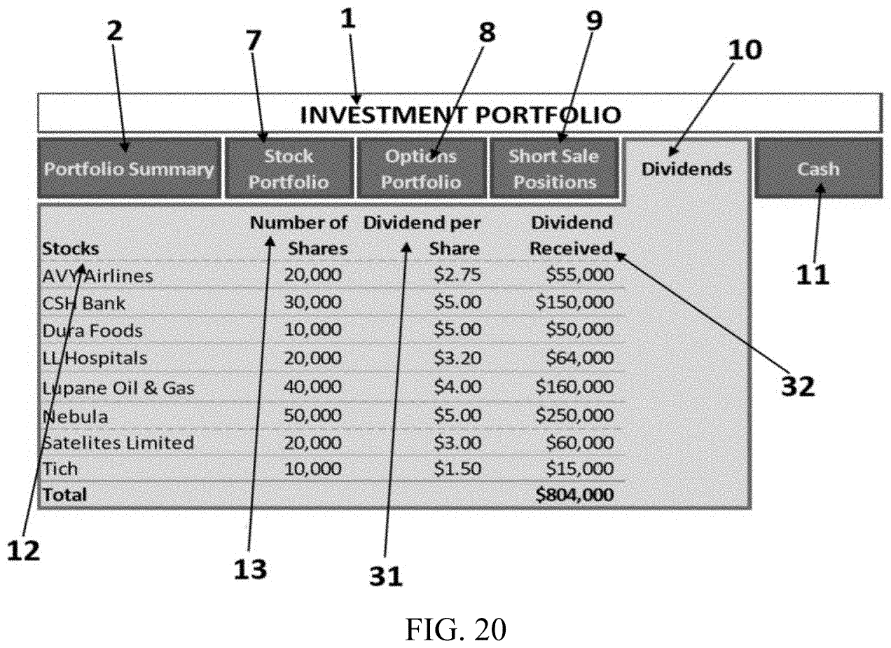

FIG. 20 is a screenshot of dividends 10 for the game of the present invention, in accordance with an embodiment. Further, the dividends 10 may provide a breakdown of all dividends 10 a player account may have received. Further, for each dividend payment the dividends 10 may show each of the respective stocks 12 that paid the dividend, number of shares.

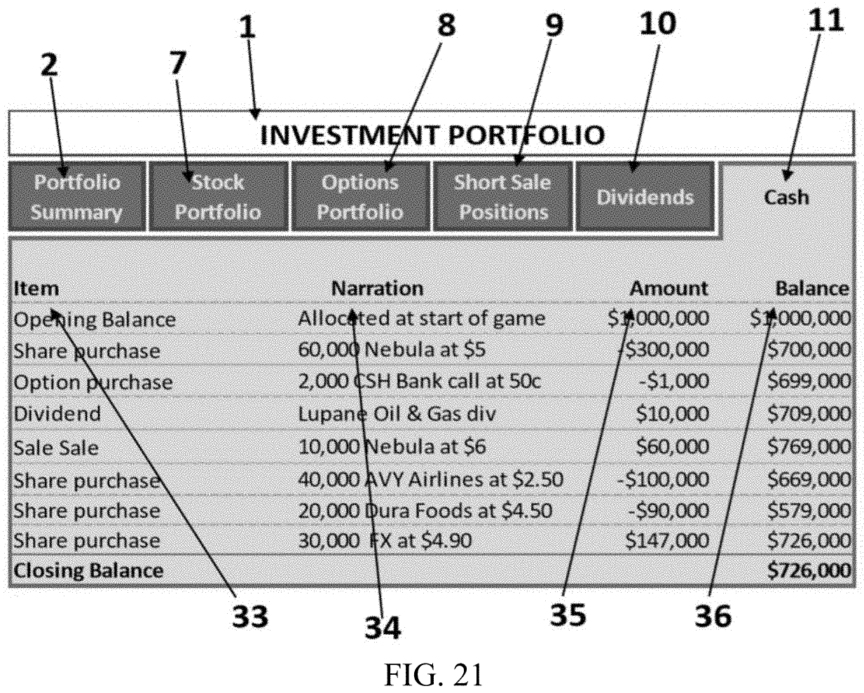

The usable-funds ledger or cash tab of the investment portfolio may provide an account of how a player account may utilize an initial amount in transactions to arrive at the closing cash balance. FIG. 21 is a screenshot of the usable-funds ledger or cash 11 for the game of the present invention, in accordance with an embodiment. Further, the cash 11 may provide an account of how a player account may utilize an initial amount in transactions to arrive at the closing cash balance. Further, the cash 11 may include a statement of the player account. Further, the statement may provide detail of all cash movements associated with the player account since the start of the game. Further, an item 33 may be the main identifier of the cash transaction. Further, the item 33 may include an initial allocation, a purchase of stock, a sale of stock, a purchase of call or a put option, a sale of call or a put option, a proceeds from short sale, a tax payment, a no-trade penalty charge, and a brokerage refund. Further, a narration 34 may provide more detail about the transaction. Further, an amount 35 may be the value of the transaction. Further, a balance 36 may be the amount of cash the player account may have after executing the transaction.

FIG. 22 is a screenshot of a playing board 40 for the game of the present invention, in accordance with an embodiment. Further, the screenshot of the playing board 40 may display all the squares on which the bell 42 may land on. Further, there may be thirty-two squares in the playing board 40. Further, the thirty-two squares may include twenty-four trading squares 44, four corner squares 41 and four player option squares 43. Further, at any given time only seven squares may be displayed on the playing board 40 so that a plurality of player accounts playing the game may see where the dice may land with the next throw. Further, at the start of a game, each player account from the plurality of player accounts may turn the bell 42 present on the leftmost square. Further, at the start of the game, the bell 42 may rest on the starting square known as the opening bell. Further, the game progresses by throwing the dice. Further, the number that may appear on the dice, the bell 42 may move along the playing board 40 for the same number of squares. Further, a round, as in round to expiry, may be completed when the bell 42 that may have started at the opening bell square moves across the playing board with a successive throw of dice. Further, when the bell 42 return or go past the opening bell square to complete the round. Further, the round may be recorded each time the opening bell goes past the opening bell square.

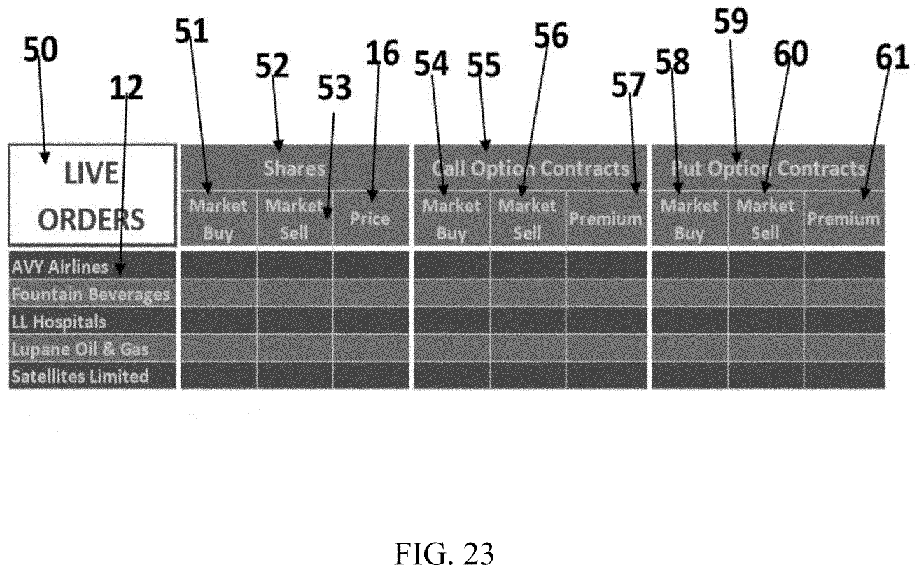

FIG. 23 is a screenshot of live orders 50 for the game of the present invention, in accordance with an embodiment. Further, the live order screenshot may include five stocks 12 and options available for trading. Further, for each stock the live orders 50 may provide information such as a share market buy, a share market sell 52, a price 16, a call option buy, a call option sell, a call option premium 57, a put option buy, a put option sell, a put option premium and so on. Further, the share market buy may include a total number of shares a player account want to buy. Further, the share market buy may be a summation of a plurality of player shares buy 63 in my orders 62, from a plurality of player accounts playing the game. Further, the share market sell 52 may include a total number of shares available for sale. Further, the share market sell may be a summation of a plurality of players shares sell 64 in my orders 62, from the plurality of player accounts playing the game. Further, the price 16 may be a current share price. Further, considering a case of no competitive bidding the price 16 may be equal to a price indicated on the price sheet 70. Further, considering a case of competitive bidding the highest buy price from the plurality of player accounts in my orders 62, may become the price 63 further becoming the share market buy in live orders 50. Further, the call option buy may include a total number of call option contracts the player account may want to buy. Further, the call option buy may be a summation of a plurality of players call option buy 65 in my orders 62, from the plurality of player accounts playing the game. Further, the call options sell may include a total number of call option contracts the player account may want to sell. Further, the call options sell may be a summation of a plurality of player call option sell 66 in my orders 62, from the plurality of player accounts playing the game. Further, the call option premium 57 may include a current or market premium for the stock's call option and may be 10% (one-tenth) of the current price 16. Further, the put option buy may include a number of put option contract the player account want to buy. Further, the put option buy may include a summation of a plurality of players put option buy 68 in my orders 62, from the plurality of player accounts playing the game. Further, the put option sell may include a number of put option contract the player account want to sell. Further, the put option sell may include a summation of a plurality of players put option sell 69 in my orders 62, from the plurality of player accounts playing the game. Further, the put option premium 61 may include a current or market premium for the stock's put option and may be 10% (one-tenth) of the current price 16

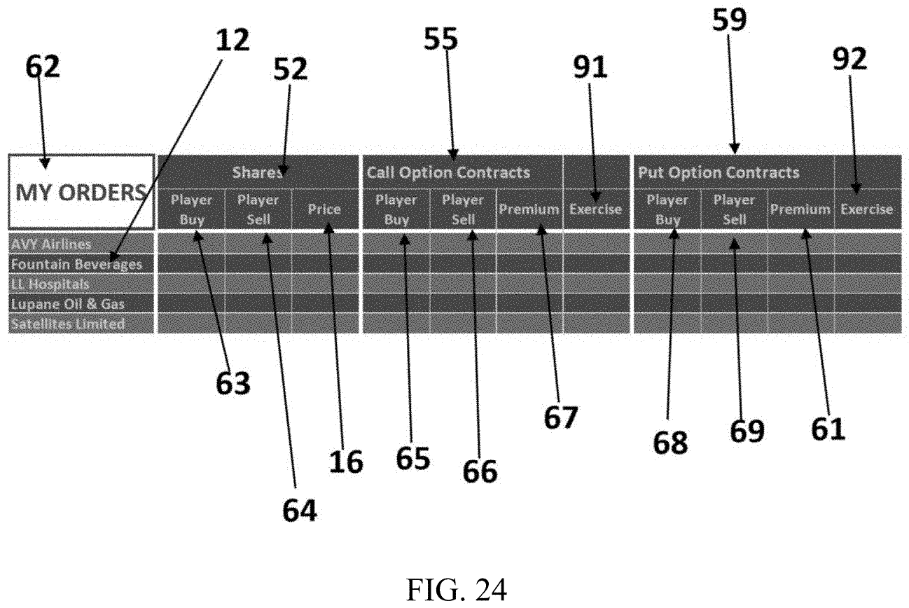

FIG. 24 is a screenshot of my orders 62 for the game of the present invention, in accordance with an embodiment. Further, the my orders 62 may display the same stocks 12 and options as displayed in a live orders 50. Further, the my orders 62 may allow a player account to input options to buy and/or sell a stock. Further, a player account may buy (place bid) or sell (offer) stocks 12 by entering the information such as a player shares buy 63, a player shares sell 64, a price 16, a player call option buy 65, a player call option sell 66, a call option premium 67, a call option exercise 91, a player put option buy 68, a player put option sell 69, a put option premium 61, a put option exercise 92 and so on. Further, the player shares buy 63 may include a number of shares the player may want to buy. Further, the player shares buy 63 must be less than or equal to the cash closing balance 11 available in the investment portfolio 1 of the player account, as shown in FIG. 21. Further, the player shares sell 64 may include a number of shares the player account may want to sell. Further, the player shares sell 64 may not exceed the number of shares held in the investment portfolio 1 by the player account, as shown in FIG. 17. Further, the price 16 may be a price at which the player account may wish to trade stocks 12. Further, the price may be a current price 16 on the price sheet 70, as shown in the FIG. 25. Further, the player account may change the price in competitive bidding. Further, the player call option buy 65 may include a number of call option contracts the player account may want to buy. Further, the value of the player call option buy 65 may not exceed the cash closing balance 11 available in the investment portfolio 1 of the player account, as shown in the FIG. 21. Further, the player call options sell 66 may include a number of call option contracts the plurality of player accounts may want to sell. Further, the player call option sell 66 may not exceed the number of call option contract held by the player account. Further, the call option premium 67 may be a current premium for the stock's call option and may be 10% (one-tenth) of the price 16 which may be changed by competitive bidding. Further, the call option exercise 91 may include a number of contracts the player account may want to exercise. Further, the player put option buy 68 may include a number of put option contracts the plurality of player accounts may want to buy. Further, the value of the player put option buy 68 may not exceed the cash closing balance 11 available in the investment portfolio 1 of the player account, as shown in the FIG. 21. Further, the player put option sell 69 may include a number of put option contracts the plurality of player accounts may want to sell. Further, the player put option sell 69 may not exceed the number of put option held by the player account. Further, the put option premium 61 may be a current premium for the stock's put options and may be 10% (one-tenth) of the price 16 which may be changed by competitive bidding. Further, the put option exercise 92 may include a number of contracts to exercise from a one or more of portfolios associated with the one or more of player accounts. FIG. 25 is a screenshot of a price sheet 70 for the game of the present invention, in accordance with an embodiment. Further, the price sheet 70 may include a list for each stock. Further, the list may include an initial price 71, a price 16 and a direction of the most recent price movement 72, (up or down). Further, the initial price 71 may be a stock's starting or a listing price. Further, the price 16 may be a stock's market or latest price at which trades are executed, options may be priced and the investment portfolio 1 may be valued. Further, at the start of a game, the price 16 may be set to the initial price 71. Further, the price 16 may be subsequently changed as dictated by the news cards 76 or after competitive bidding.

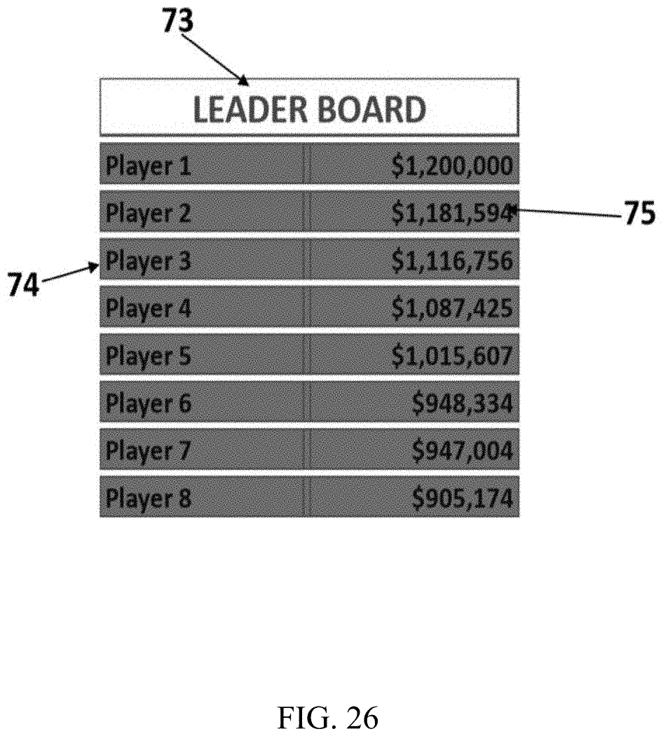

FIG. 26 is a screenshot of a leader board 73 for the game of the present invention, in accordance with an embodiment. Further, the leader board 73 may include a list. Further, the list may include one or more player accounts and the corresponding worth of the one or more of the player accounts in a game. Further, the leader board 73 may act as a notification alert by lighting up the name of a player account from the one or more of player accounts with the turn and flashing name of the player account when the player account may be supposed to do something.

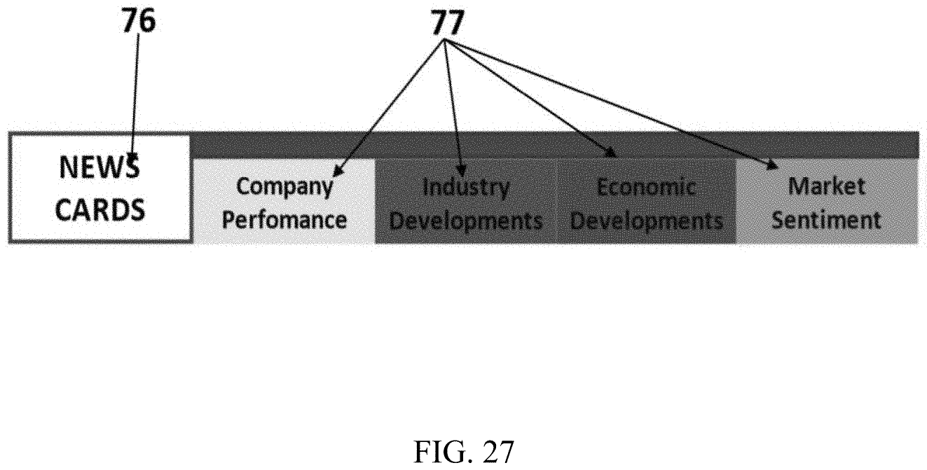

FIG. 27 is a screenshot of virtual cards 77 for the game of the present invention, in accordance with an embodiment. Further, the virtual cards 77 may include categories such as company performance (marked in yellow color), economic developments (marked in pink color), industry developments (marked in blue color) and market sentiment (marked in green color). Further, the four colors may be associated with the trading squares 44 colors on the playing board 40. Further, each color may appear six times on the twenty-four trading squares 44 provided on the playing board 40. Further, when the bell 42 may land on a trading square, the square light up along with the same colored news card. Further, after the conclusion of the trading the lit-up virtual cards 77 may pop up and may reveal the news items. Further, one or more of player accounts playing the game may read the news posted on the virtual card and click on the virtual card to mark the completion of the reading process. Further, after the completion of the reading process by the one or more of player accounts the prices of affected stocks 12 may be changed on the price sheet 70.

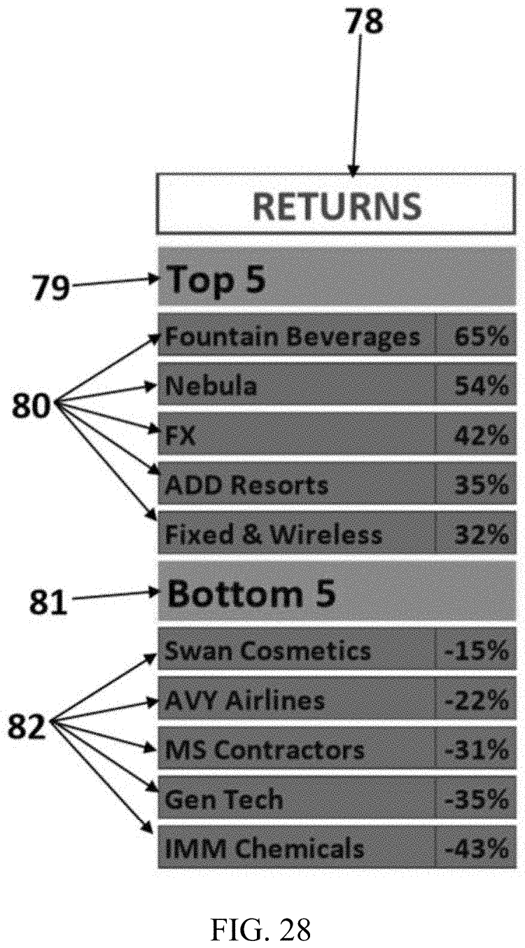

FIG. 28 is a screenshot of returns (top 5 and bottom 5) 78 for the game of the present invention, in accordance with an embodiment. Further, the returns (top 5 and bottom 5) 78 may display the five best-performing stocks 79. Further, the five best stock may include the stocks 80 which may show the greatest increase in price 16 from the initial price 71. Further, the returns (top 5 and bottom 5) 78 may display the five worst performing stocks 81. Further, the five worst stock may include the stocks 82 which may show the greatest decrease in price 16 from the initial price 71. Further, the returns (top 5 and bottom 5) 78 may display all stocks in order of most profitable (best performer) to least profitable (worst performer).

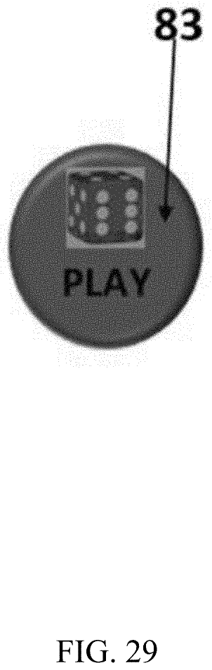

FIG. 29 is a screenshot of a play button 83 for the game of the present invention, in accordance with an embodiment. Further, the play button 83 may include a play button 83 and dice. Further, the play button 83 may be clicked by one or more of player accounts to roll the dice. Further, clicking the play button 83 a dice icon spins for two seconds and stops to display the dice number. Further, the bell 42 may move along the playing board 40 the number of squares according to the number displayed on the dice. Further, the play icon may flash to indicate the player account turn to click the play button 83.

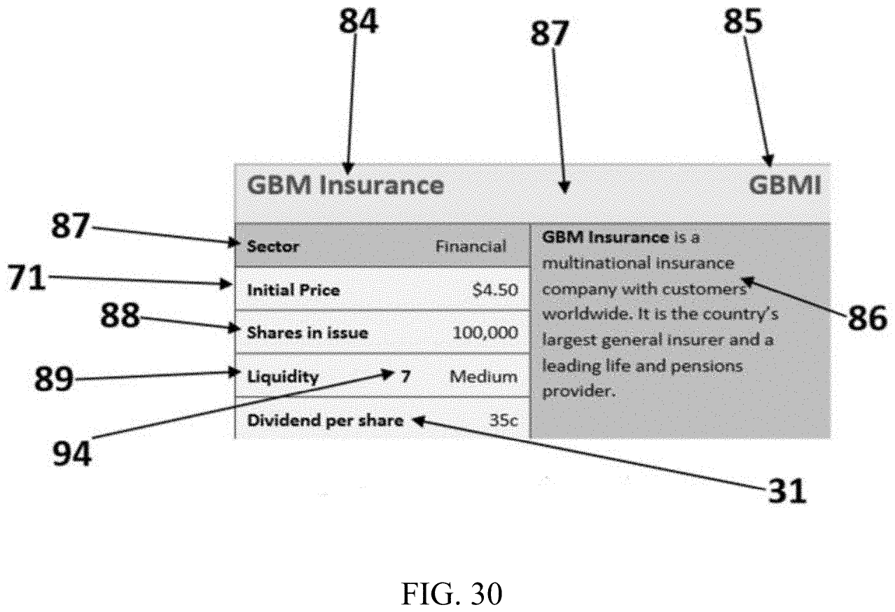

FIG. 30 is a screenshot of a sample stock fact sheet for the game of the present invention, in accordance with an embodiment. Further, the sample stock fact sheet may include the full name of the company 84 and the stock code of the company 85. Further, the sample fact sheet may also provide a brief description of the company business 86. Further, a sector color 87 may be associated with the company name 84. Further, the company name 84 may be written in a color unique to the sector. Further, there may be eleven sectors with at least two companies in each sector. Further, the initial price 71 may be the starting price of the stock and multiplying the starting price of the stock by the number of shares issued 85 may provide the market capitalization 94. Further, the market capitalization 94 for the 25 companies may range from $150,000 to $700,000. Further, the market capitalization 94 may determine the liquidity 89. Further, the liquidity 89, in an instance, may be low, medium, or high depending on the size of the company. Further, the liquidity of the company may indicate the number of times the stock may appear on the twenty-four trading squares 44. Further, the stocks 12 may only be traded when the bell 42 lands on a trading square with that stock as one of the five on the square.

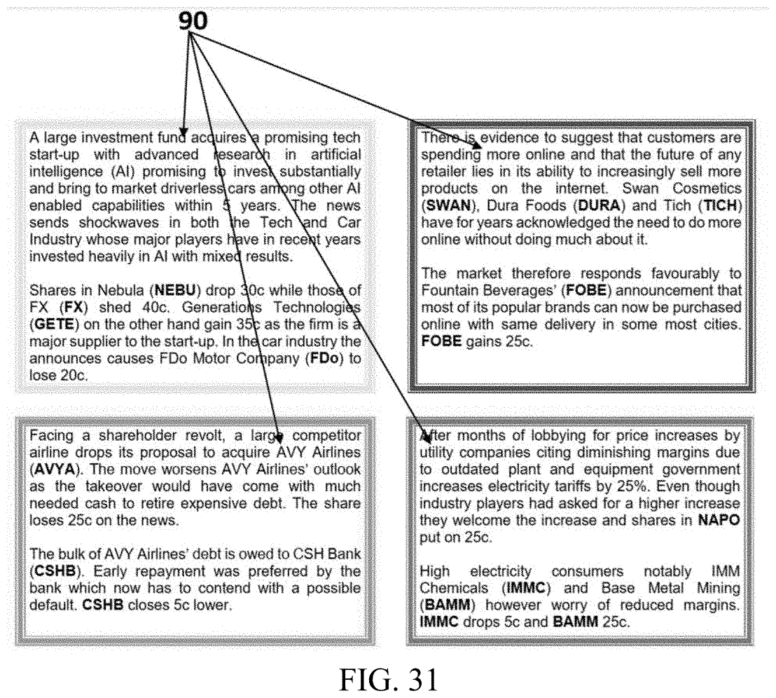

FIG. 31 is a screenshot of sample virtual cards 90 for the game of the present invention, in accordance with an embodiment. Further, the sample may include four sample news cards 90. Further, the virtual cards may be the main driver of share prices on the game of the present invention. Further, the game may recreate over 100 everyday real-life news items through virtual cards. Further, the virtual cards may be grouped into four categories namely company performance (marked in yellow color), economic developments (marked in red color), industry developments (marked in blue color) and market sentiment (marked in green color). Further, each virtual card may reveal an event whose occurrence may have the intended effect of moving a single or several share prices upwards or downwards by different magnitudes and not necessarily in the same direction.

Although the invention has been explained in relation to its preferred embodiment, it is to be understood that many other possible modifications and variations can be made without departing from the spirit and scope of the invention as hereinafter claimed.

What is claimed is:

1. A method for a virtual stock market sharing and trading game, the method comprises the steps of:
(A) providing a plurality of player accounts and a plurality of virtual stocks managed by at least one remote server, wherein each player account is associated with a corresponding player personal computing (PC) device, and wherein each player account includes a usable-funds ledger and an investment portfolio;
(B) providing a virtual gameboard and a plurality of game actions managed by the remote server, wherein the virtual gameboard includes a loop of game spaces, and wherein each game space is associated with at least one corresponding game action from the plurality of game actions, and wherein a virtual game piece for each player account is situated onto a current game space from the loop of game spaces, and wherein the virtual gameboard is associated with a winning cash threshold;
(C) executing a virtual dice roll for a specific player account with the remote server;
(D) moving a virtual game piece for the specific player account from the current game space to a new game space in accordance to the virtual dice roll with the remote server, wherein the new game space is from the loop of game spaces;
(E) executing the corresponding game action of the new game space with the remote server;
(F) updating the usable-funds ledger and the investment portfolio for the specific player account in accordance to the corresponding game action of the new game space with the remote server;
(G) executing a plurality of iterations for steps (C) through (F), wherein the specific player account for each iteration cycles through the plurality of player accounts; and
(H) designating a winning player account with the remote server, if the usable-funds ledger of the winning player account is greater than or equal to the winning cash threshold.

2. The method for a virtual stock market sharing and trading game, the method as claimed in claim 1 comprises the steps of:
providing the new game space as a trading game space, wherein the trading game space includes a plurality of stock affiliations, and wherein each stock affiliation is associated with a corresponding virtual stock from the plurality of virtual stocks;
prompting the specific player account to enter a share buy/sell request for at least one desired stock affiliation with the corresponding player PC device during step (E), wherein the desired stock affiliation is from the plurality of stock affiliations;
relaying the share buy/sell request from the corresponding player PC device of the specific player account to the remote server, if the share buy/sell request is entered by the specific player account; and
executing the share buy/sell request between the specific player account and the corresponding virtual stock of the desired stock affiliation with the remote server.

3. The method for a virtual stock market sharing and trading game, the method as claimed in claim 1 comprises the steps of:
providing the new game space as a trading game space, wherein the trading game space includes a border color;
providing a plurality of virtual card decks managed by the remote server, wherein each virtual card deck includes a color theme, a news theme, and a plurality of virtual cards, and wherein each virtual card includes at least one stock modification, and wherein the stock modification is contextually related to the news theme;
prompting the specific player account to randomly select a single virtual card from a specific virtual card deck with the corresponding player PC device during step (E), if the border color of the new game space matches the color theme of the specific virtual card deck, wherein the specific virtual deck is from the plurality of virtual card decks, and the single virtual card is from the plurality of virtual cards of the specific virtual card deck;
relaying a random selection of the single virtual card from the corresponding player PC device of the specific player account to the remote server, if the single virtual card is randomly selected by the specific player account; and
applying the stock modification of the single virtual card to the plurality of virtual stocks with the remote server.

4. The method for a virtual stock market sharing and trading game, the method as claimed in claim 1 comprises the steps of:
providing the new game space as a forced-sale game space;
providing the investment portfolio with a plurality of bought-share sets, wherein each bought-share set is associated with a corresponding virtual stock from the plurality of virtual stocks;
prompting the specific player account to enter a share liquidation request for an undesired bought-share set with the corresponding player PC device during step (E), wherein the undesired bought-share set is from the plurality of bought-share sets of the specific player account;
relaying the share liquidation request from the corresponding player PC device to the remote server, if the share liquidation request is entered by the specific player account; and
executing the share liquidation request between the specific player account and the corresponding virtual stock of the undesired bought-share set with the remote server.

5. The method for a virtual stock market sharing and trading game, the method as claimed in claim 1 comprises the steps of:
providing an opening-bell game space amongst the loop of game spaces, wherein the opening-bell game space includes a fine amount;
withdrawing the fine amount from the usable-funds ledger of the specific player account with the remote server during step (E), if the investment portfolio does not include a single bought-share set, and if the new game space is the opening-bell game space; and
withdrawing the fine amount from the usable-funds ledger of the specific player account with the remote server during step (E), if the investment portfolio does not include a single bought-share set, and if the opening-bell game space is passed by the virtual game piece of the specific player account while travelling from the current game space to the new game space during step (D).

6. The method for a virtual stock market sharing and trading game, the method as claimed in claim 1 comprises the steps of:
providing the new game space as a brokerage-refund game space, wherein the brokerage-refund game space includes a refund amount; and
depositing the refund amount into the usable-funds ledger of the specific player account with the remote server during step (E).

7. The method for a virtual stock market sharing and trading game, the method as claimed in claim 1 comprises the steps of:
providing the new game space as a compulsory-delisting game space;
prompting the specific player account to select an undesired virtual stock with the corresponding player PC device during step (E), wherein the undesired virtual stock is from the plurality of virtual stocks;
relaying the selection of the undesired virtual stock from the corresponding player PC device to the remote server, if the undesired virtual stock is selected by the specific player account; and
liquidating the undesired virtual stock into the usable-funds ledger of each player account with the remote server.

8. The method for a virtual stock market sharing and trading game, the method as claimed in claim 1 comprises the steps of:
providing the new game space as a dividend game space, wherein each virtual stock includes a dividend rate;
providing the investment portfolio with a plurality of bought-share sets, wherein each bought-share set is associated with a corresponding virtual stock from the plurality of virtual stocks;
proportionately assessing a dividend amount for the corresponding virtual stock of each bought-share set of the specific player account in accordance to the dividend rate with the remote server; and
depositing the dividend amount for the corresponding virtual stock of each bought-share set into the usable-funds ledger of the specific player account with the remote server.

9. The method for a virtual stock market sharing and trading game, the method as claimed in claim 1 comprises the steps of:
providing the new game space as a buy-or-sell game space, wherein each virtual stock includes an initial share price;
providing the investment portfolio with a plurality of bought-share sets, wherein each bought-share set is associated with a corresponding virtual stock from the plurality of virtual stocks;
prompting the specific player account to enter a share buy/sell request for at least one desired bought-share set with the corresponding player PC device during step (E), wherein the desired bought-share set is from the plurality of bought-share sets of the specific player account;
relaying the share buy/sell request for the desired bought-share set from the corresponding player PC device to the remote server, if the share buy/sell request for the desired-bought share set is entered by the specific player account; and
executing the share buy/sell request between the specific player account and the corresponding virtual stock of the desired bought-share set with the remote server.

10. The method for a virtual stock market sharing and trading game, the method as claimed in claim 1 comprises the steps of:
providing the new game space as a rights-issue game space, wherein each virtual stock includes an initial share price;
prompting the specific player account to enter a share buy request for at least one desired virtual stock with the corresponding player PC device during step (E), wherein the desired virtual stock is from the plurality of virtual stocks;
relaying the share buy request for the desired virtual stock from the corresponding player PC device to the remote server, if the share buy request for the desired virtual stock is entered by the specific player account; and
executing the share buy request at the initial share price between the specific player account and the desired virtual stock with the remote server.

11. The method for a virtual stock market sharing and trading game, the method as claimed in claim 1 comprises the steps of:
providing a new game space as a capital-gains-tax game space, wherein the capital-gains-tax game space includes a tax calculation process;
providing the investment portfolio with a plurality of bought-share sets, wherein each bought-share set is associated with a corresponding virtual stock from the plurality of virtual stocks;
prompting the specific player account to select a taxable bought-share set with the corresponding player PC device during step (E), wherein the taxable bought-share set is from the plurality of bought-share sets of the specific player account;
relaying the selection of the taxable bought-share set from the corresponding player PC device to the remote server, if the taxable bought-share set is selected by the specific player account;
executing the tax calculation process in accordance to the corresponding virtual stock of the taxable bought-share set with the remote server in order to assess a proportionate tax amount for the corresponding virtual stock of the taxable bought-share set; and
withdrawing the proportionate tax amount from the usable-funds ledger of the specific player account with the remote server.

12. The method for a virtual stock market sharing and trading game, the method as claimed in claim 1 comprises the steps of:
prompting each player account to view the investment portfolio with the corresponding player PC device; and
displaying the investment portfolio of at least one arbitrary account with the corresponding player PC device, if the investment portfolio is selected to be viewed by the arbitrary account, wherein the arbitrary account is any account from the plurality of player accounts.

13. The method for a virtual stock market sharing and trading game, the method as claimed in claim 1 comprises the steps of:
prompting each player account to view the usable-funds ledger with the corresponding player PC device; and
displaying the usable-funds ledger of at least one arbitrary account with the corresponding player PC device, if the usable-funds ledger is selected to be viewed by the arbitrary account, wherein the arbitrary account is any account from the plurality of player accounts.
